(19) United States
(12) Patent Application Publication
(10) Pub. No.: US 2023/0166612 A1
(43) Pub. Date: Jun. 1, 2023

(54) KERBSTONE MODULE, KERBSTONE MODULE GROUP, CHARGING STATION, AND METHOD FOR OPERATING APPARATUSES OF THIS KIND

(71) Applicant: INSTATE GMBH, München (DE)

(72) Inventor: Sven STUBENRAUCH, München (DE)

(21) Appl. No.: 17/922,568

(22) PCT Filed: Apr. 30, 2021
(86) PCT No.: PCT/EP2021/061377

§ 371 Date: Oct. 31, 2022

(30) Foreign Application Priority Data
Apr. 30, 2020 (DE) 10 2020 205 561.0

(51) Int. Cl. B60L 53/31; B60L 53/12; E01C 11/22; H02J 50/00; H02J 50/40

(52) U.S. Cl. CPC B60L 53/31; B60L 53/12; E01C 11/22; H02J 50/005; H02J 50/402

(57) ABSTRACT

The present invention relates to a curb module 1 having a base body 10. The base body 10 has a cavity which is surrounded by walls of the base body 10. A charging device 20 is provided in the cavity, wherein the charging device 20 comprises at least one transmission unit 22. The at least one transmission unit 22 of the charging device 20 is configured such that it is capable of transmitting electrical energy to an external consumer. Furthermore, the present invention also relates to a curb module assembly comprising at least two such curb modules 1 and a charging station comprising at least one such curb module 1. Finally, the present invention also relates to a method for operating such devices.

The present invention relates to a curb module for charging at least partially electrically powered vehicles, and to a curb module assembly comprising such curb modules and a corresponding charging station. Furthermore, the present invention relates to a method for operating such devices.

In times of emerging electromobility, the need for possibilities for charging at least partially electrically driven vehicles is increasing. In this context, solutions are particularly sought for public spaces, since the supply of electrical energy to the respective at least partially electrically driven vehicle must also be ensured outside and far away from the home. This is of considerable importance for the transition to electric mobility, especially in view of the still limited ranges of such vehicles, whether (partially) electric vehicles for passenger and/or goods transport, (partially) electrically powered motorbikes or bicycles or other (partially) electrically powered vehicles.

Up to now, charging columns have been regularly installed in public spaces to charge such vehicles. Such charging columns are usually designed in the style of a conventional petrol pump and are usually permanently located along parking strips on streets or in inner- or outer-city car parks. These charging columns are usually placed on the footpath and/or cycle path adjacent to the road. As a rule, the space required for the installation of the charging pole is available there, without having to take up the parking spaces or street areas, which are already tightly dimensioned in public spaces, and thus further reduce their size. Even if such charging columns are functional and provide a suitable option for supplying electric power to such vehicles, they considerably reduce the usable area of the footpaths and/or cycle paths. Furthermore, they have a negative impact on the cityscape. In order to counteract these problems, there are already considerations to install corresponding charging facilities in street lamps. This would probably mean that separate charging points could be dispensed with. However, existing street lamps usually have little or no free space inside for a charging infrastructure, or in order to provide this required space at all, they have to be retrofitted with an additional, projecting mounting option for the charging device, e.g. in the form of an additional housing. However, this additional housing, if it can be attached to the streetlight at all, increases the space requirement and entails a not inconsiderable installation effort. Furthermore, a charging cable must be routed from the vehicle to be charged to the modified streetlight, usually via the footpath and/or cycle path. This then considerably restricts the freedom of movement of pedestrians and/or bicycles as well as the occupants of the vehicle to be charged and, in addition, represents a serious traffic obstruction and risk of injury.

Thus, it is a task of the present invention to propose an alternative possibility for a device for charging at least partially electrically driven vehicles. This alternative possibility should be particularly suitable for public spaces and the large-scale implementation of a suitable charging solution here.

This task is solved by a curb module, a curb module assembly and a charging station according to the independent claims of the present document. Advantageous embodiments of these configurations are apparent from the respective dependent claims. Furthermore, the present invention solves the need for a suitable method for operating such devices.

According to a first aspect of the present invention, a curb module according to the invention comprises a base body having a cavity, wherein the cavity is at least partially surrounded by walls of the base body. That is, the cavity is provided in the base body. A charging device is provided in said cavity. The charging device comprises at least one transmission unit. The at least one transmission unit of the charging device is configured such that energy transmission to an external recipient coupled to the transmission unit is possible via said transmission unit.

In other words, the curb module comprises a charging device in its interior, which enables charging of an energy storage device of an at least partially electrically driven vehicle at least in a clearly defined transmission range. Exemplary designs of such a transmission unit are plugs, designs with threaded sections and/or inductive transmission units. Such a curb module is thereby modelled on a conventional curb in terms of its external shape and its strength. Thus, the curb module according to the invention can be inserted and used at the roadside instead of a conventional curb and fully take over its previous functions. In addition, an at least partially electrically driven vehicle parked on the street or in a car park next to or in the immediate vicinity of the curb module can be charged with the aid of a corresponding charging cable with a suitable recipient via the curb module according to the invention. Due to the immediate vicinity of the vehicle to be charged to the curb module, the corresponding charging cable can be routed directly along the vehicle to the curb module. This advantageously eliminates or minimizes both obstructions and a potential risk of injury from the charging cable. Furthermore, the corresponding curb module does not take up space of the footpath and/or cycle path adjacent to the road, nor does the corresponding curb module take up space of the parking area itself, as it merely replaces a curb that is otherwise provided and present anyway. This provides a particularly functional option for charging at least partially electrically powered vehicles in public spaces that blends seamlessly into the original cityscape.

Advantageously, at least one of the transmission units provided in the curb module according to the invention is designed as an inductive transmission unit, which is capable of generating a magnetic field for inductive energy transmission in at least one corresponding transmission area over at least a partial section of one of the walls of the base body provided. Inductive transmission units generate an alternating magnetic field for energy transmission and are particularly well protected from external environmental influences such as dirt and/or corrosion. Thus, particularly durable and low-maintenance as well as easy-to-operate designs of the curb module according to the invention can be realized.

Advantageously, the charging device of the curb module has more than one separate transmission unit. In this case, the multiple transmission units are preferably provided and arranged in such a way that, by means of this plurality of transmission units, a corresponding energy transmission from the curb module to the vehicle to be charged is possible in different transmission areas on different sections of the base body. This makes it advantageously possible to charge several vehicles simultaneously via a single curb module. This is of particular advantage, for example, if the curb module according to the invention is used as a demarcation between different parking spaces. This is because the vehicles on all sides of the curb module can then be loaded independently of each other via the same curb module.

Advantageously, in such an embodiment, the multiple transmission units are designed to enable identical and/or different energy transmission rates in the respective transmission areas. Identical energy transmission rates enable simultaneous charging of a plurality of identical vehicles, as described above. Different energy transmission rates can be used to charge vehicles with different requirements for the charging process and/or to enable different charging modes, such as particularly economical and battery-saving charging (ECO charging) or also fast charging (SPEED charging), by means of a single curb module according to the invention. In particular, some of the transmission units provided can also be designed to enable different energy transmission rates themselves. Such multifunctional transmission units can then, for example, also be provided alongside single-functional transmission units with only one specific energy transmission rate.

Advantageously, the curb module has at least one marking which indicates to the user the position of a corresponding transmission area. Such markings can be formed, for example, as colored circles or similar markings or also as light elements, for example as LEDs, on or in the surface of the curb module. These enable or facilitate the correct positioning or attachment of a recipient of the charging cable at the respective transmission area.

Preferably, the walls of the base body completely enclose the cavity. Such a design is self-contained and ensures suitable protection of the components of the charging device arranged within the cavity from external influences such as moisture and/or dirt and/or mechanical or other types of damage.

Preferably, the base body of the curb module is formed in one piece. Such a design is particularly solid and thus stable. A one-piece design is also understood to be a variant which is originally formed from several partial elements, but the partial elements are then connected to each other in a non-detachable manner, e.g. welded or firmly glued. Alternatively, the base body can also be formed from several partial elements, which are then detachably connected to each other by suitable means. Suitable means would be, for example, clamps, screw connections, form-fitting surfaces or the like, which enable a stable and permanent but nevertheless detachable connection of the partial elements of the base body with a corresponding seal. The variant with several partial elements considerably facilitates the handling of the curb module, as this can be at least partially disassembled particularly easily for maintenance of the charging device, for example.

Preferably, the curb module is in the form of a high curb. High curbs are used particularly frequently, which means that the possible applications of the curb module according to the invention are particularly diverse. However, alternative design forms for a curb module according to the invention would also be, for example, round curbs, low curbs, bus capstones, transition stones or any special forms of curbs. Thus, corresponding curb modules can be used in a wide variety of locations and in a wide variety of functions as required.

Preferably, the base body of the curb module is at least partially, but in particular completely, made of concrete or plastic. It is particularly preferred if the base body is also fiber-reinforced, preferably by means of carbon fibers. Concrete and plastic appear to be particularly suitable. The desired or required shapes are particularly easy to form from concrete and plastic. In addition, these materials have many known physical advantages such as weather and/or UV resistance as well as robustness with regard to damage. In particular, with regard to concrete designs, it is also proposed in accordance with the invention to use electrically conductive concrete, preferably in variants with an inductive transmission unit. In an advantageous manner, electrically conductive concrete only minimally influences the efficiency of the inductive energy transmission, so that transmission losses during the inductive charging process can be further reduced and thus the charging efficiency can be further increased. Alternatively, the base body of the curb module can also be formed from a suitable natural stone. Although natural stones usually require more effort to shape, they are regularly significantly more stable and/or durable than other materials and also usually offer a more appealing appearance. Thus, an optimal adaptation and integration of the curb module to or into the existing environment can be realized.

Preferably, at least one inductive transmission unit is arranged entirely within the cavity of the base body and is designed to generate the magnetic field for the inductive charging process through the corresponding wall of the base body. This means that the transmission unit is particularly well protected by the base body of the curb module against negative external influences such as moisture and/or dirt and/or mechanical or other types of damage.

Preferably, at least one transmission unit, in particular an inductive one, is arranged completely within the cavity of the base body. In this case, the wall to which the corresponding transmission area is provided has an opening at the respective section.

The opening is closed with a removable cover. The cover can preferably be made of a material permeable to magnetic fields. For example, the cover can be made of a corresponding plastic. This design makes it possible to access the interior of the cavity, and in particular the corresponding transmission unit, through the opening after removing the cover. This enables maintenance of the transmission unit and/or replacement of the transmission unit. The cover ensures that no dirt can get into the cavity through the opening and/or that unauthorized persons can access the transmission unit from the outside as long as the cover is positioned accordingly on the opening. The cover can be locked by means of a corresponding mechanism so that it cannot be removed without first unlocking the mechanism.

Preferably, the wall on which a corresponding transmission area for the energy transmission is formed has an opening at the respective section of the wall. In this case, at least one transmission unit, in particular an inductive transmission unit, has a transmission element which is provided at least partially in said opening. In this case, the respective transmission element preferably closes the entire opening. Such an embodiment enables a variant with a wall that has a particularly thick wall thickness and thus enables a particularly stable configuration without influencing the transmission performance of the transmission unit too much.

Preferably, the curb module has at least one positioning device which is designed to position and hold an external, in particular inductive, recipient in the corresponding transmission area. This makes it possible to securely hold the external recipient in the transmission area, in particular during the charging process. Examples of such positioning devices are plugs, threaded sections, permanent magnets and/or activatable electromagnets. If the intended positioning device is in the form of a permanent magnet or electromagnet, in the case of only inductive transmission units, the positioning device can preferably be provided in such a way that the positioning device does not influence the external shape of the curb module. This means that the curb module obtained is also particularly resistant to soiling of the positioning device or damage to the positioning device, for example caused by improper handling, and also offers no obstruction or risk of injury due to protruding parts, indentations and the like.

Preferably, at least one transmission unit is designed as an inductive transmission unit and is designed in such a way that the magnetic field generated in the respective transmission area is strong enough to enable a sufficiently strong energy transmission for charging a battery of an at least partially electrically driven vehicle. The usual charging power to be achieved for normal charging is up to about 22 kW. However, especially for fast charging, higher charging powers are also desirable and can be realized with the transmission unit according to the invention.

Preferably, the charging device comprises a coupling unit. The coupling unit has an input connection via which the charging device of the curb module according to the invention can be connected to an external power supply. Via such a coupling unit, a reliable supply of the curb module by means of an external energy or power supply, such as via the public power grid, is possible. Alternatively, the external power supply can also be in the form of a solar module or a similar independent energy supply which enables the charging device according to the invention to be operated as intended.

Preferably, the coupling unit further comprises at least one output connection via which the charging device can be connected to external devices. Examples of, corresponding external devices could be, for example, further curb modules according to the invention and/or intermediate transmission curbs or connection lines. Furthermore, external devices can also be any other devices which are operated with electric power. Examples would be a hoover or an air compressor for cleaning the vehicle or inflating the vehicle's tires. Thus, the curb module according to the invention can be used not only for charging a corresponding vehicle, but also for supplying other devices with electrical energy. In particular, the at least one output connection is designed to be connected to the input connection of another curbstone module according to the invention via a corresponding connecting line. Thus, according to the invention, it is possible to couple several curb modules according to the invention with each other and/or with the interposition of transmission curbs and/or connecting lines and thus to form a curb module assembly according to the invention (see below) and/or a charging station according to the invention (see below) in a particularly simple and flexible manner.

Preferably, the charging device comprises a control unit. The control unit is preferably coupled to the other components of the charging device and is designed to control the operation of the charging device. For this purpose, the control unit may, for example, have components such as a computer unit, an internal data memory for operating parameters and/or function programs as well as transformers, rectifiers and/or inverters. Such a control unit enables a particularly reliable and versatile control of the charging device and thus in particular of the charging functions of the curb module according to the invention. However, purely analogue control units would also be conceivable. In particularly advantageous embodiments, the control unit can also be designed to control other devices connected to the curb module, such as further curb modules. This is particularly advantageous if the intended curb module is to be integrated or is integrated into a curb module assembly and/or a charging station according to the present invention (see below).

Preferably, the charging device comprises a receiving and/or transmitting unit or a bidirectional communication unit. In this context, the receiving and/or transmitting unit is designed to receive signals from at least one external device, in particular via a wireless connection, and to transmit them to at least one of the other components of the charging device, and/or to receive signals from at least other components of the charging device and to transmit them to at least one external device, in particular via a wireless connection. Via such a receiving and/or transmitting unit or bidirectional communication unit, it is possible, for example, to transmit control signals to the charging device via an external device in a particularly uncomplicated manner and/or to read out operating parameters of the charging device and, for example, to have them displayed via the external device. Examples of particularly preferred external devices are a smartphone known per se or a control and/or display panel, which can be provided on a corresponding charging cable. Many different standards, such as Bluetooth or the like, are known as possibilities for the wireless, bidirectional transmission of data and signals. The receiving and/or transmitting unit or bidirectional communication unit can, for example, also be in simultaneous exchange with several different external devices. In a particularly advantageous embodiment, the receiving and/or transmitting unit can, for example, transmit information to a central server via a radio network as to whether a charging process is currently being carried out at a curb module and/or whether a corresponding parking area in front of the curb module is free. This would then also make it conceivable to implement an alternative design in such a way that a user is guided to a free curb module that is ready for charging, for example by integrating the vehicle's navigation device.

Preferably, the charging device has a buffer storage for at least temporary storage of electrical energy. This makes it possible, on the one hand, to compensate for short-term fluctuations in the electrical energy supply and, on the other hand, to enable at least temporary self-sufficient operation of the curb module by means of the electrical energy stored in the buffer storage. Furthermore, the corresponding buffer storage can be used to temporarily store surplus electrical energy and to release it again as soon as it is needed. In other words, the buffer storage can not only contribute to the improved function of the curb module according to the invention, but can also be used to positively support the overall energy management of the curb module according to the invention.

Preferably, the curb module and here in particular the charging device comprises a status display device for displaying a status of the charging device. The status display device is provided and designed in such a way that it is visible in a curb module installed in the usual manner. In other words, the status indicator is preferably designed to display relevant information to a user before, during or after a charging process. Examples of such information may be that the curb module is ready to carry out a charging process (for example via a green light), that a charging process is active or running (for example via a blue light), that a charging process has been completed or that no charging process is currently possible at the corresponding curb module (for example via a red light). A particularly preferred design of the status display device here is by means of LED lights and/or an LED light ring. LED variants are particularly reliable, durable and energy-saving.

Preferably, the status display device is provided in the corresponding section of the wall under or at a respective transmission area or at least in its immediate vicinity. At the same time, the status display device can also serve as a marker for the transmission area or at least interact with it, thus making it considerably easier for the user to handle the curb module. In this regard, the status indicator device is designed and arranged in such a way that the status indicator device can be easily viewed before, during and after the loading process.

Another aspect of the present invention relates to a curb module assembly. The curb module assembly according to the invention comprises at least two of the curb modules according to the invention described above. In this regard, the curb modules of the curb module assembly according to the invention are coupled to one another via corresponding connecting lines in such a way that an exchange of energy and/or information is possible between them. In other words, several of the curb modules according to the invention can be combined and interconnected to form a curb module assembly. Such a curb module assembly can then be provided along a roadway, parking area or the like, so as not to have to connect each curb module individually with a separate connection to a power supply.

Furthermore, the exchange of information between curb modules provides many opportunities to coordinate and optimize the operation of individual curb modules. To enable the exchange of information, the coupling of the curb modules in the curb module assembly according to the invention can alternatively also take place wirelessly, in particular via the receiving and/or transmitting units or bidirectional communication units of the curb modules.

Preferably, the curb module assembly comprises at least one transmission curb module. Preferably, the transmission curb module comprises a cable passage for guiding and protecting a corresponding connecting line connecting at least two curb modules according to the invention. Alternatively, a corresponding connecting line can also be provided in the transmission curb module itself, which has corresponding coupling elements at its two ends. A connection to a curb module according to the invention and/or to a further transmission curb module can then be made via the coupling elements. Thus, the curb modules according to the invention do not necessarily have to be provided or arranged directly next to each other in a corresponding curb module assembly. Rather, the curb modules according to the invention can also be provided or arranged at a distance from each other corresponding to the usual length of vehicles. In this case, the transmission curb modules enable the desired transmission of energy and/or information between the curb modules according to the invention and thereby prevent gaps in the curb formed. According to the invention, a transmission curb module can also be designed in the form of a distributor, so that the connection of a plurality of curb modules and/or transmission curb modules according to the invention is possible, should, for example, the individual road layout into which the curb module assembly is to be fitted require it. Alternatively or additionally, a corresponding curb module assembly may of course also comprise one or more conventional curbs. Preferably, a control unit of at least one of the provided curb modules of the curb module assembly according to the invention is adapted to control also the components of other curb modules of the curb module assembly connected to this curb module. This enables central control of the various curb modules of the curb module assembly, and thus particularly functional and central control thereof.

According to a further aspect of the present invention, a charging station for charging at least partially electrically driven vehicles comprises a switch box which is connected, or at least connectable, to a power supply network. In this context, the use of the term switch box in the following also includes an electrical circuit provided therein and necessary for operating the curb module or curb module assemblies according to the invention. A switch box in the sense of the invention can also be, for example, a circuit in a street light and/or a circuit provided for connecting a street light, as well as similar embodiments. The charging station according to the invention further comprises at least one of the curb modules according to the invention described above and/or one of the curbs module assemblies according to the invention described above. In this case, the at least one curb module or at least one of the curb modules according to the invention is coupled to the switch box in such a way that all of the curb modules provided according to the invention can be supplied with electrical energy via the control box. In this case, the power supply of further curb modules according to the invention is preferably provided via connecting lines between the curb modules according to the invention. It is therefore possible to connect only one curb module according to the invention directly to the switch box and thus to the electrical energy source and to supply the entire curb module assembly with electrical energy via this. The switch box can either be an (existing) above-ground switch box or be provided underground. Such a design can provide a particularly stable power supply for the intended curb modules. In cities, in particular, corresponding switch boxes can be found in sufficient quantities in a wide variety of places, which makes it particularly easy to integrate the curb modules according to the invention into the urban infrastructure. The switch box can also be designed separately, but should then be provided in such a way that it does not ultimately lead to the previously mentioned negative effects of conventional charging stations.

Preferably, in such a charging station the provided curb modules are usually laid along a roadway and/or parking area. In particular, the provided curb modules replace conventional curbs. In this way, the charging station according to the invention blends particularly well and inconspicuously into the already existing cityscape and streetscape without leading to the previously described disadvantages of known charging stations. According to a further aspect of the present invention, a method according to the invention for operating one of the devices according to the invention described above comprises the following steps: in a first step, information is retrieved on at least one device to be charged, in particular on an at least partially electrically driven vehicle, information is retrieved on a desired charging process and/or information is retrieved on the curb module(s) itself and/or on a corresponding power supply; in a second step, a suitable charging strategy for the device(s) to be charged is determined based on the retrieved information; and in a third step, a charging process is carried out for the device(s) to be charged. By means of such a method, a wide variety of aspects for optimizing one or more charging processes of devices according to the invention, in particular but not exclusively at least partially electrically powered vehicles, can be considered in the operation of these devices.

Preferably, the first to third steps of the method are carried out again at specific intervals and/or in response to a specific triggering event in order to adapt the charging strategy to any changed conditions or information. In this way, the application of an optimal charging strategy for the device(s) to be charged can always be ensured.

Preferably, the retrieved information includes at least information on a current state of charge of the device(s) to be charged, a prioritization of the corresponding charging processes, an intended charging duration and/or an electrical power available at the corresponding curb module. This information is particularly helpful in selecting an optimal charging strategy. For example, a corresponding charging strategy can include a sequence of the different charging processes and/or an optimal time for this.

Preferably, the determination of the suitable charging strategy, in particular in a control unit of the curb module or in the control unit of one of the curb modules provided, is carried out centrally for the entire curb module or for all the curb modules provided in a curb module assembly. In this way, particularly simple and yet functional designs can be achieved.

In the following, advantageous embodiments of the present invention are described with reference to figures, wherein

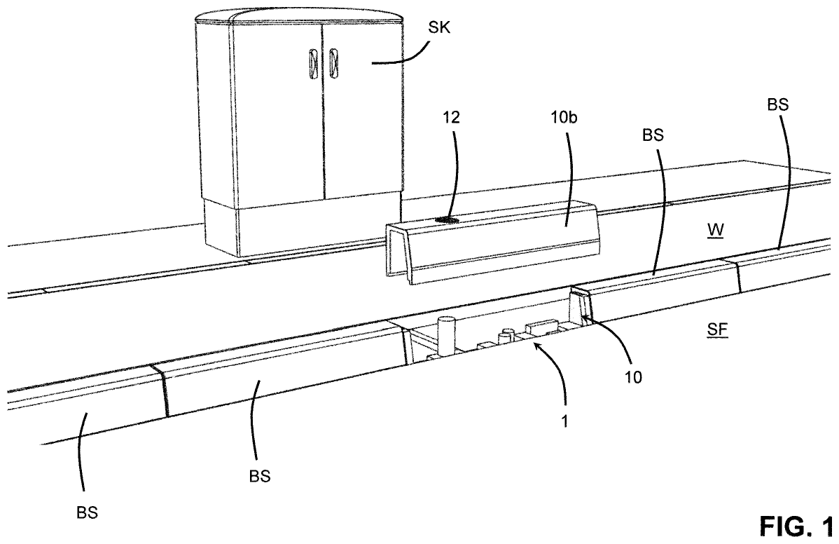

FIG. 1 is a representation of an opened curb module according to the invention or of a charging station in the installed state;

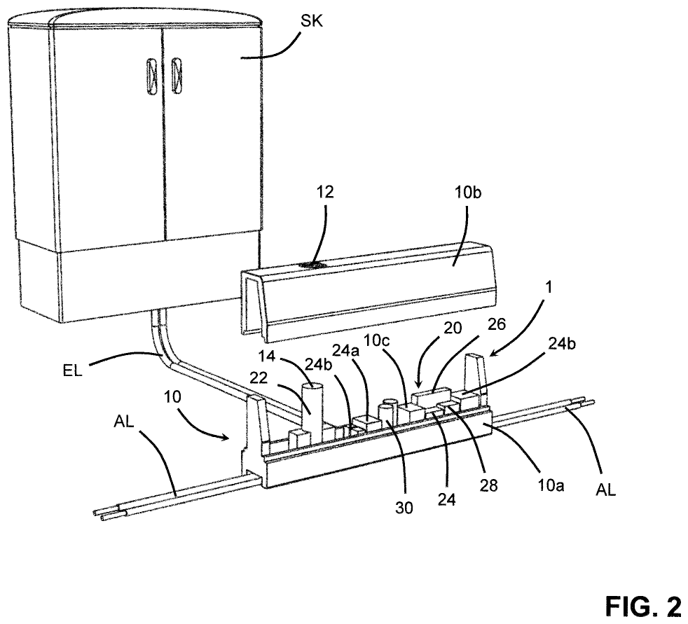

FIG. 2 is a reduced representation of the components shown in FIG. 1;

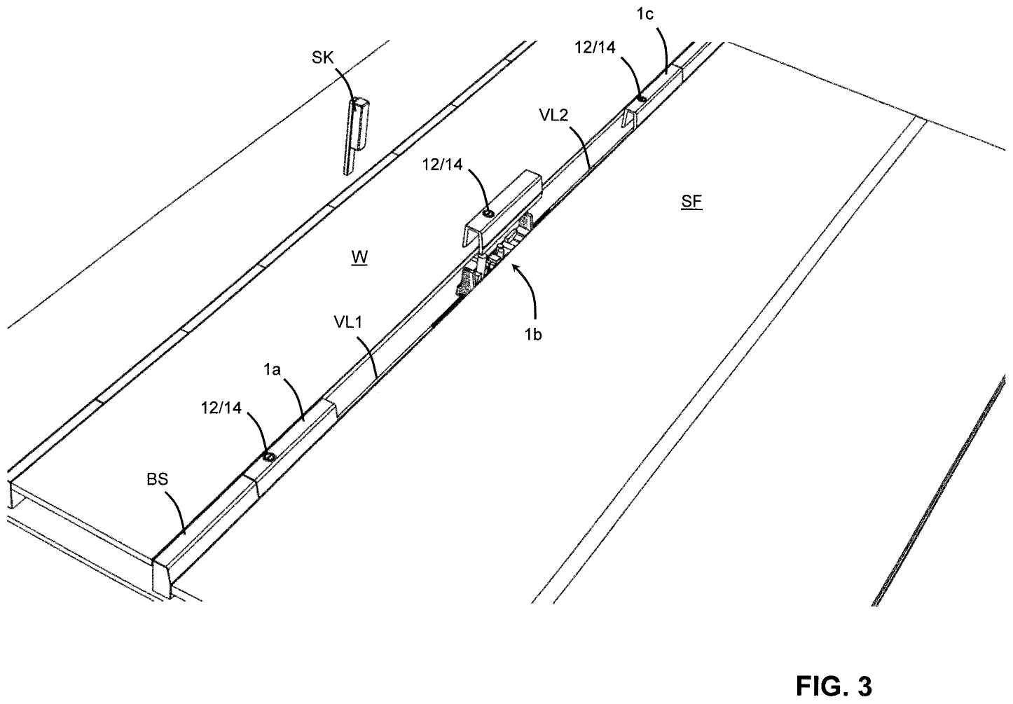

FIG. 3 is an at least partial representation of a further charging station according to the present invention with a curb module assembly according to the invention.

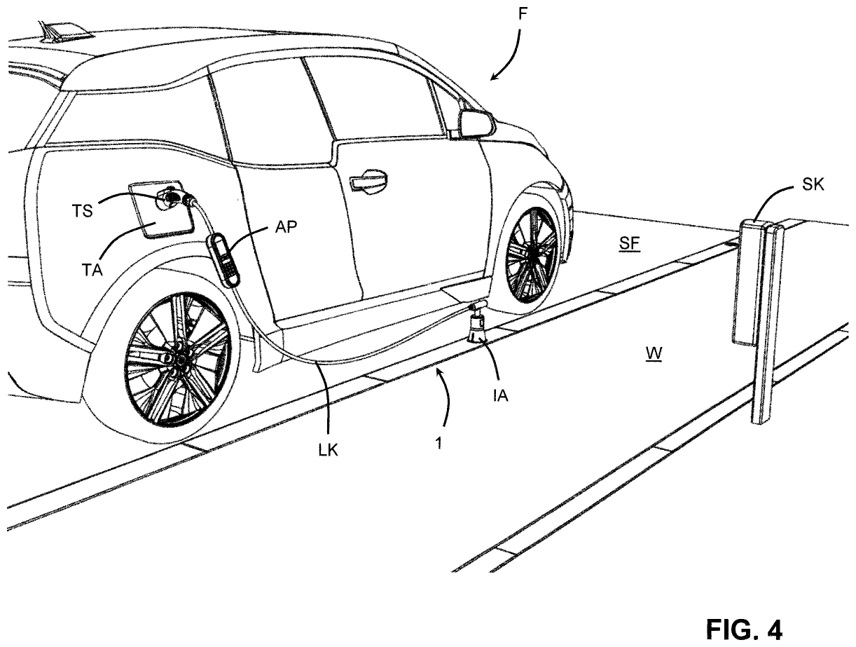

FIG. 4 shows an at least partially electrically powered vehicle during charging at a charging station according to the present invention; and

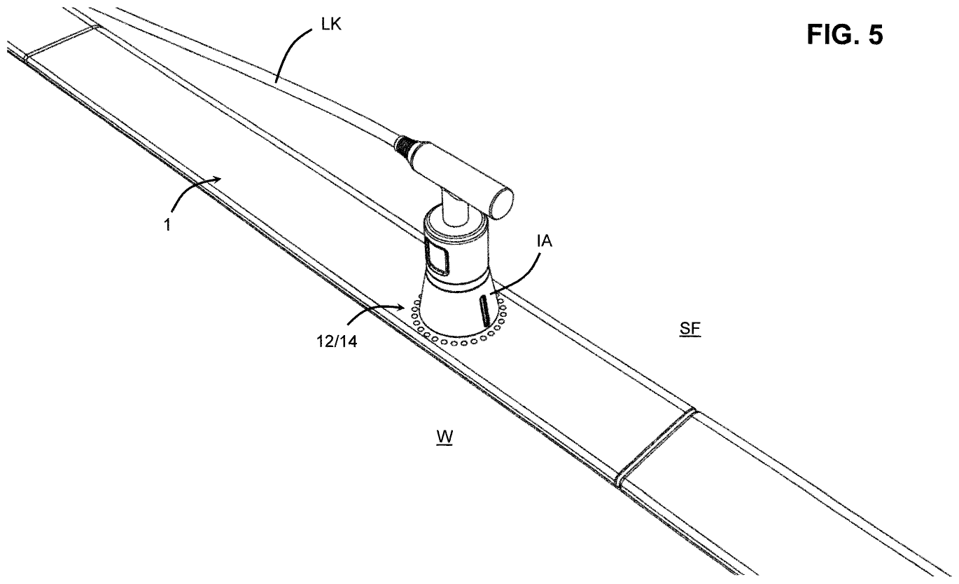

FIG. 5 shows an enlarged view of the inductive recipient shown in FIG. 4 on the curb module according to the invention.

In the embodiments shown, identical and/or corresponding components are referenced with the same or at least similar reference signs for the sake of clarity. However, it should be expressly noted that the figures are merely intended to illustrate the subject matter of the present invention by means of possible embodiments. The attached figures are not to be understood as limiting the claimed subject-matter. The subject-matter is in fact defined only by the claims.

As can be seen from FIG. 1, a curb module 1 according to the invention is designed to be used instead of conventional curb modules, for example as a transition from a road surface SF to a footpath and/or bicycle path W. Here, the curb module 1 according to the invention is provided, for example, between two conventional curbs BS. Alternatively, a curb module 1 according to the invention may also serve as a boundary or transition between road surfaces, parking areas and/or their surroundings (such as, for example, a green strip or the like). For this purpose, a skilled person is familiar with a wide variety of designs for corresponding curb modules, such as high curbs, flat curbs or the like.

In the embodiment, a conventional switch box SK is provided on the side of the footpath and/or cycle path W opposite the curb module 1 according to the invention, such as can be found in many places at or in the immediate vicinity of the roadside. Such a switch box SK can also be arranged underground or integrated into a building as an alternative to the free-standing embodiment shown. In this case, it is not a component of the curb module 1 according to the invention, but together with it forms a charging station according to the invention.

As can be seen particularly well in FIG. 2, the embodiment shown here for a curb module 1 according to the invention comprises a base body 10, which in the present embodiment is formed from a base element 10a and a cover element 10b. The base element 10a and the cover element 10b can be releasably coupled to one another (in this case via a form fit) and, as partial elements of the base body 10, form its walls. In the assembled state of the partial elements 10a and 10b of the base body 10, they form a cavity in their interior which is completely surrounded by the base body 10. A corresponding charging device 20 is provided or arranged in the cavity. The outer shape of the curb module 1 shown in the embodiment corresponds to that of a high curb, even if other designs are conceivable within the scope of the invention. The material of the partial elements 10a and 10b of the base body 10 is here plastic reinforced by means of carbon fibers, but can also be concrete, such as in particular conductive concrete, or correspondingly shaped natural stone. Here, the base body 10 additionally has a support wall 10c, which strengthens the structural stability of the base body 10 and thus of the curb module 1. Other suitable support structures are also conceivable.

In the particularly preferred embodiment shown here, the charging device 20 provided comprises a transmission unit 22, a coupling unit 24, a control unit 26, a receiving and transmitting unit 28 and an electrical buffer storage 30.

Here, the transmission unit 22 is configured as an inductive transmission unit 22 and is configured such that it is able to generate a varying magnetic field by means of a corresponding transmission element (here in the upper region of the transmission unit 22) through a corresponding partial section of the respective wall (here the upper wall of the cover element 10b) in a predefined transmission area (directly above the transmission element). Thereby, at least in the predefined transmission area, the magnetic field has a strength sufficient for inductive charging of electrically driven vehicles. In the illustrated embodiment, only one inductive transmission unit 22 is provided. However, designs with several, and then in particular differently configured, transmission units 22 are also conceivable. Here, the inductive transmission unit 22 is also provided entirely within the cavity and is designed to generate said magnetic field through the corresponding wall of the base body 10. However, other embodiments are also possible, such as having an opening and a corresponding cover or transmission element within the corresponding wall.

In the present embodiment, in order to make it easier for a user to locate the predetermined transmission area, the cover element 10b has a corresponding marking 12 on its upper surface indicating the position of the transmission area. Here, the marking 12 is formed as a transparent plastic ring, under which a controllable LED illuminated ring 14 is provided. By indicating a current status of the charging device 20 via a suitable control, for example by means of different luminous colors, the LED illuminated ring 14 serves as a status indicating device 14. A corresponding status indicating device 14 can also be provided independently of a corresponding marking 12, but must of course be clearly visible from the outside when the curb module 1 is installed. In the embodiment shown, a positioning device (not explicitly shown) in the form of a controllable electromagnet or a permanent magnet is also provided in such a way that, with the aid of a constant magnetic field, it can appropriately position and hold or fix an inductive recipient IA for picking up the inductive power in the transmission area, at least during the charging phase. This helps a user to obtain the most efficient and stable charging process possible.

The provided coupling unit 24 of the charging device 20 comprises here an input connection 24a and two output connections 24b1 and 24b2, wherein input connection 24a is provided to be connected to an external power supply via one or more corresponding input line(s) EL. In the embodiment shown, the switch box SK (with the circuitry therein) serves as an intermediate element for connecting the curb module 1 according to the invention to the public power supply. Via the output connections 24b1 and 24b2 provided, the curb module 1 according to the invention in the embodiment shown can be connected to external devices such as, for example, further curb modules 1 according to the invention via corresponding output lines AL.

It should be noted that the specific designations of the corresponding connections 24a, 24b1 and 24b2 and connecting lines EL and AL chosen in the context of the description of the embodiment example were chosen merely to make them easier to distinguish. However, no restriction is to be derived from this to the effect that signals and/or energy can/can only be transmitted in a single direction via the respective connections 24a, 24b1 and 24b2 and/or connecting lines EL and AL. In the case of a further curb module according to the invention connected to the curb module 1 shown in FIG. 2, for example, the left-hand output connection can serve to connect to the right-hand output connection 24b2 of the curb module 1 shown. Both power and information can then be exchanged between the two curb modules according to the invention via a corresponding connecting line coupled thereto. Such an embodiment is shown, for example, in FIG. 3 and will be explained in more detail later. In this regard, the coupling unit of the further curb module according to the invention may either have no further connections or at least one further output connection for coupling to further external devices. Of course, corresponding connections for coupling to external devices other than curb modules according to the invention can also be provided. An example of this would be, for example, conventional plug connections for connecting and charging electrically powered devices (for example, at least partially electrically powered vehicles or other devices such as hoovers or compressors).

The control unit 26 is coupled to the other provided components of the charging device 20 and is designed to control the operation of the charging device 20, i.e. all its components, accordingly. For this purpose, the control unit 26 is equipped, for example, with a data storage, a computing unit, an inverter and/or a rectifier and/or with other suitable electrical components. If a data storage with a connected computing unit is provided, various programs for corresponding control of the components of the charging device 20 are stored thereon and can be called up by the latter. However, it would also be conceivable to design the control unit 26 as a passive or analogue control unit and not to provide an active computing unit.

Via the receiving and transmitting unit 28, the control unit 26 connected thereto can be supplied with signals, such as control signals, from an external device, such as a smartphone, or communicate with such a device. Furthermore, it is also possible to transmit a corresponding feedback to the external device via the receiving and transmitting unit 28. Such signal transmission preferably takes place via a wireless connection such as via Bluetooth or the general radio network.

The buffer storage 30 for electrical energy enables a more stable operation of the charging device 20. Furthermore, this buffer storage 30 can at the same time serve as a buffer storage for stabilizing the public power grid or the public power supply, for example in order to compensate or intercept fluctuations in the amount of electricity produced. Examples of such buffer storage 30 can be conventional accumulators or also particularly powerful capacitors. Buffer storage 30, in which the electrical energy is converted into mechanical stress or similar, would also be conceivable and usable in principle.

FIG. 3 shows a further example of a charging station according to the present invention.

Here, this comprises a curb module assembly with three curb modules 1a, 1b and 1c according to the invention. Here, the middle curb module 1b is essentially identical to the curb module 1 described above.

The two outer curb modules 1a and 1c are also designed very similarly to the curb module 1 described above, but each have only one coupling unit with only one input connection provided on the side. The two output connections 24b1 and 24b2 of the middle curb module 1b are connected to one of the input connections of the other curb modules 1a and 1c respectively via corresponding connecting lines VL1 and VL2. Via these connecting lines VL1 and VL2, both an exchange of energy and an exchange of information with the further curb modules 1a and 1c can take place. In the embodiment shown, the connecting lines VL1 and VL2 are (still) exposed. However, in the installed or final state of the charging station, these run under conventional curb modules BS or run at least partially through transmission curb modules (not shown) specially provided for this purpose. Such transmission curb modules may then have, for example, a cable passage for the corresponding connecting lines VL1 and VL2, or connecting lines VL1 and VL2 permanently integrated into the transmission curb modules with corresponding connections for direct coupling to the curb modules 1a, 1b and 1c according to the invention and/or to intermediate elements provided for this purpose.

The charging station further comprises a switch box SK with a circuit (not shown) arranged therein. The switch box SK together with the circuit is provided for connecting the curb module in a suitable manner to a corresponding power supply, such as here for example the public power grid. In this respect, the middle curb module 1b, as shown in FIG. 2, is connected to the switch box SK by means of an input line EL laid under the footpath and/or cycle path W. The switch box SK is provided with a power supply. In other words, the power supply to the middle curb module 1b is provided directly via the switch box SK, while the other two curb modules 1a and 1c are connected to the switch box SK via the middle curb module 1b in order to be supplied with electrical power.

Even if the switch box is shown above ground and free-standing in the embodiment shown, it is preferable to provide it underground if possible or, for example, integrated into a house wall. It is particularly preferred if the switch box integrated into the charging station is a switch box SK already pre-installed at a corresponding location. In this case, no further switch box SK needs to be provided. The concrete external design of the switch box generally has no influence on the core of the invention and can thus be chosen more or less freely. However, it should be avoided to design the switch box in such a way that the previously described disadvantages of conventional charging stations are obtained.

It should be noted that a corresponding charging station can also comprise less than three or more than three curb modules 1, 1a, 1b and/or 1c according to the invention.

However, in order to be able to be particularly well integrated into the already existing cityscape and streetscape, the curb modules 1a, 1b and 1c provided are to be laid in usually along corresponding roadways and/or parking spaces, etc. In other words, the building block modules 1a, 1b and 1c according to the invention are intended to replace conventional curbs and to take over their functions and to extend them by the possibility of charging an at least partially electrically driven vehicle F. Any transmission curbs provided are also intended to replace conventional curbs when installed. An exemplary charging process with a curb module according to the invention is shown in FIG. 4.

An at least partially electrically driven vehicle F is parked on a parking area provided for this purpose next to the respective curb module 1. Then a tank connection TA of the vehicle F is connected to the curb module 1 according to the invention via a charging cable LK. For this purpose, the charging cable LK has a tank connector TS at a first end and an inductive recipient IA at its second end. An enlarged representation of the exemplary inductive recipient shown here is shown in FIG. 5. However, as such are known per se, its specific design will not be further discussed here. FIG. 5 also shows the LED illuminated ring with its artificial ring, which functions as a marker 12 and status indicator 14. During a charging process, the inductive recipient IA is suitably positioned and held in the intended transmission area via the above-mentioned positioning magnet.

The charging cable LK shown here also has a control and/or display panel AP, via which the charging process can be controlled, information about the charging process can be called up or payment functions can be carried out. The control and/or display panel AP provided can be an external device for wireless signal exchange with the receiver and/or transmitter unit 28 of the charging device 20. In principle, however, charging cables LK without such control and/or display panels AP can also be connected to a curb module 1 according to the invention.

As can be seen particularly well in FIG. 4, for the charging process with the curb module 1 according to the invention, the charging cable LK can be routed directly along the vehicle F and thus does not obstruct the freedom of movement around the vehicle F or that on the footpath and/or cycle path.

As an alternative to charging the vehicle F using the charging cable LK, other variants are of course also conceivable. For example, a gripper connected to the vehicle in a fixed but movable manner with a corresponding inductive recipient IA could be used for this purpose.

An exemplary method for operating the devices described here comprises the following: in a first step, information on at least one device to be charged, in particular on an at least partially electrically driven vehicle, information on a desired charging process and/or information on the curb module(s) 1, 1a, 1b and/or 1c themselves and/or on a corresponding power supply is retrieved, for example from a smartphone, one of the curb modules or from other external devices; in a second step, a suitable charging strategy for the device(s) to be charged is determined based on the retrieved information; and in a third step, a charging process for the device(s) to be charged is executed.

These steps are performed again from the beginning at specific intervals and/or in response to a specific triggering event, such as a user input. This allows the charging strategy to be adapted regularly and/or on request to any changes in conditions or information. The information retrieved can include at least information on a current state of charge of the device(s) to be charged, a prioritization of the corresponding charging processes, an intended charging duration and/or an electrical power available at the corresponding curb module. This can be used to determine a particularly suitable charging strategy.

Here, the determination of the suitable charging strategy is carried out in the control unit 26 of the curb module 1b centrally for all curb modules 1a, 1b and 1c provided.

The embodiments shown and described merely serve to illustrate the core idea of the present invention and serve as an example of a possible implementation of this core idea. However, the scope of protection is defined only by the patent claims.

### REFERENCE SIGNS

1 Curb module
1a Left-hand curb module
1b Middle curb module
1c Right-hand curb module
10 Base body
10a Base element
10b Cover element
10c Support wall
12 Marker
14 Status indicator/LED light ring
20 Charging device
22 Transmission unit
24 Coupling unit
24a Input connector
24b1 First output connector
24b2 second output connector
26 Control unit
28 Receiving and transmitting unit
30 Buffer storage
AL Output line
AP Control and display panel
BS Conventional curb
EL Input line
F Vehicle
IA Recipient
LK Charging cable
SF Road surface
SK Switch box
TA Tank connection
TS Tank connector
VL1 first connecting line
VL2 second connecting line
W Foot and cycle path

1. A curb module comprising
a base body, the base body having a cavity which is surrounded by walls of the base body,
wherein:
a charging device is provided in the cavity,
the charging device comprises at least one transmission unit, and
the at least one transmission unit of the charging device is configured in such a way that energy transmission to an external consumer coupled thereto is possible via said transmission unit.

2. The curb module according to claim 1, wherein the transmission unit is an inductive transmission unit, which is capable of generating a magnetic field for inductive energy transmission in at least one transmission area over at least a partial section of one of the provided walls of the base body.

3. The curb module according to claim 1, wherein:
the charging device comprises more than one separate transmission unit, and
the plurality of transmission units are provided in such a way that a corresponding energy transmission is made possible via plurality of transmission units in different transmission areas at different partial sections of the base body.

4. The curb module according to claim 3, wherein the plurality of transmission units are designed to enable identical and/or different energy transmission rates in the respective transmission areas.

5. The curb module according to claim 1, wherein the curb module has at least one marker indicating the position of a corresponding transmission area.

6. The curb module according to claim 1, wherein the walls of the base body completely enclose the cavity.

7. The curb module according to claim 1, wherein the base body of the curb module is formed in one piece or is formed from a plurality of partial elements which are detachably connected to one another by suitable means.

8. The curb module according to claim 1, wherein the curb module is in the form of a high curbstone.

9. The curb module according to claim 1, wherein the base body of the curb module is formed at least partially from concrete or plastic or is formed from a natural stone.

10. The curb module according to claim 1, wherein at least one transmission unit is arranged entirely within the cavity of the base body and is designed to generate said magnetic field through the corresponding wall of the base body.

11. The curb module according to claim 1, wherein:
at least one transmission unit is arranged entirely within the cavity of the base body and that wall over which the corresponding transmission area is provided has an opening at the respective partial section, and
the opening is closed by a cover.

12. The curb module according to claim 1, wherein:
that wall on which a corresponding transmission area for the energy transmission is formed has an opening at the respective partial section of the wall, and
at least one transmission unit comprises a transmission element which is provided at least partially in said opening.

13. The curb module according to claim 1, wherein the curb module has at least one positioning device, which is designed to position and hold an external recipient in a corresponding transmission area.

14. The curb module according to claim 1, wherein at least one transmission unit is designed as an inductive transmission unit and is configured such that the magnetic field generated in the respective transmission area is strong enough to enable sufficiently strong energy transmission for charging a battery of an at least partially electrically driven vehicle.

15. The curb module according to claim 1, wherein:
the charging device comprises a coupling unit, and
the coupling unit comprises an input connector via which the charging device can be connected to an external power supply.

16. The curb module according to claim 14, wherein:
the coupling unit further comprises at least one output connector through which the charging device can be connected to external devices, and
the at least one output connector is designed to be connected to the input connector of another curb module via a connection line.

17. The curb module according to claim 1, wherein:
the charging device comprises a control unit, and
the control unit is coupled to the other components of the charging device and is adapted to control the operation of the charging device.

18. The curb module according to claim 1, wherein:
the charging device comprises a receiving and/or transmitting unit, and
the receiving and/or transmitting unit is designed to receive signals from at least one external device and to transmit them to at least one of the other components of the charging device, and/or to receive signals from at least one of the other components of the charging device and to transmit them to at least one external device.

19. The curb module according to claim 1, wherein the charging device comprises a buffer storage for at least temporary storage of electrical energy.

20. The curb module according to claim 1, wherein the curb module, has a status indicator for displaying a status of the charging device, which is provided in such a way that it is visible in a state of the curb module when being installed in the usual manner.

21. The curb module according to claim 20, wherein the status indicator is provided in the corresponding section of the wall below at a respective transmission area of a transmission unit or at least in the immediate vicinity thereof.

22. A curb module assembly comprising:
at least two curb modules according to claim 1, and
the at least two curb modules are coupled to one another via corresponding connecting lines in such a way that an exchange of energy and/or information is possible between them.

23. The curb module assembly according to claim 22, wherein:
the curb module assembly comprises at least one transmission curb module, and
the respective transmission curb module either has a cable passage for the passage of a corresponding connecting line, which connects the at least two curb modules to one another, or a corresponding connecting line is provided in the respective transmission curb module, and the connecting line provided has coupling elements at its two ends, via which a connection to the curb modules can be made.

24. The curb module assembly according to claim 22, wherein the control unit of at least one of the curb modules is designed to also control the components of other curb modules connected to said curb module.

25. A charging station for charging at least partially electrically driven vehicles, wherein:
the charging station comprises a switch box which is connected to a power supply network,
the charging station comprises at least one curb module according to claim 1, and
the at least one curb module is coupled to the switch box in such a way that all of the curb modules can be supplied with electrical energy via the switch box.

26. The charging station according to claim 25, wherein the curb modules are laid in a conventional manner along a roadway and/or parking area.

27. A method for operating a curb module according to claim 1 wherein:
in a first step, information on at least one device to be charged, information on a desired charging process and/or information on the curb module(s) itself and/or on a corresponding power supply is retrieved;
in a second step, a suitable charging strategy for the device(s) to be charged is determined based on the retrieved information; and
in a third step, a charging process is carried out for the device(s) to be charged.

28. The method according to claim 27, wherein
the first to third steps of the method are carried out again from the beginning at specific intervals and/or in response to a specific triggering event, in order to adapt the charging strategy to any changed conditions or information.

29. The method according to claim 27, wherein the retrieved information comprises at least information on a current state of charge of the device(s) to be charged, a prioritization of the corresponding charging processes, an intended charging duration and/or an electrical power available at the corresponding curb module.

30. The method according to claim 27, wherein the determination of the suitable charging strategy is carried out centrally for the entire curb module or for all curb modules provided.
